(19) United States
(12) Patent Application Publication
(10) Pub. No.: US 2014/0324386 A1
(43) Pub. Date: Oct. 30, 2014

(54) BUILDING MANAGEMENT SYSTEM FALSE-POSITIVE FAULT INDICATIONS REDUCTION MECHANISM

(71) Applicant: ENERNOC, INC., Boston, MA (US)

(72) Inventors: Edward C. Spivey, Lafayette, CA (US); Lindsay K. Spivey, Lafayette, CA (US)

(73) Assignee: ENERNOC, INC., Boston, MA (US)

(21) Appl. No.: 14/162,838

(22) Filed: Jan. 24, 2014

Related U.S. Application Data
(60) Provisional application No. 61/816,851, filed on Apr. 29, 2013.

(51) Int. Cl. G01M 99/00

(52) U.S. Cl. CPC G01M 99/00
USPC 702/183

(57) ABSTRACT

An apparatus for detecting faults of components monitored by a building management system (BMS), including an automatic fault detection (AFD) element that monitors data samples generated by the BMS indicating operative states of the components, and that determines if components are faulty. The AFD element includes a run time modeling element and a fault detection algorithm element. The run time modeling element employs the data samples and synthesized datapoints as inputs to execute fault algorithms retrieved from a system model, and generates outputs that indicate if the components are faulty, where employment of the synthesized datapoints increases fault coverage, resulting in a reduction of false alarms. The fault detection algorithm element employs normalized and standardized datapoints representing the data samples and the synthesized datapoints to automatically select the fault algorithms for storage in the system model, where the fault algorithms are selected from a standard fault algorithm data base.

### CROSS-REFERENCE TO RELATED APPLICATIONS

This application claims the benefit of the following U.S. Provisional Applications, each of which is herein incorporated by reference for all intents and purposes.

| SERIAL | FILING | |
|---|---|---|
| NUMBER | DATE | TITLE |
| 61/816,851 | Apr. 29, 2013 | APPARATUS AND METHOD |
| (ENER.0107) | | FOR AUTOMATIC DETECTION |
| | | OF FAULTS IN A BUILDING |
| | | MANAGEMENT SYSTEM |

This application is related to the following co-pending U.S. patent applications, each of which has a common assignee and common inventors.

| SERIAL | FILING | |
|---|---|---|
| NUMBER | DATE | TITLE |
| | | APPARATUS AND METHOD FOR |
| | | SELECTION OF FAULTDETECTION |
| | | ALGORITHMS FOR A BUILDING |
| (̅E̅N̅E̅R̅.̅0̅1̅0̅7̅)̅ | | MANAGEMENT SYSTEM |
| | | VIRTUAL DATA POINT CREATION |
| | | MECHANISM FOR A BUILDING |
| | | MANAGEMENT FAULT DETECTION |
| (̅E̅N̅E̅R̅.̅0̅1̅1̅2̅)̅ | | SYSTEM |
| | | BUILDING MANAGEMENT SYSTEM |
| | | DATA NORMALIZATION AND |
| (̅E̅N̅E̅R̅.̅0̅1̅1̅4̅)̅ | | STANDARDIZATION MECHANISM |

### BACKGROUND OF THE INVENTION

1. Field of the Invention

This invention relates in general to the field of building management systems, and more particularly to an automated fault detection mechanism within facility that is administered by a building management system.

2. Description of the Related Art

A building management system (BMS) is utilized generally in larger facilities to manage and control mechanical, electrical, and plumbing subsystems therein. Often, it is function of a BMS to control energy usage by controlling lights and heating, ventilation, and air conditioning (HVAC) subsystems, security subsystems, alarm subsystems, and transportation subsystems (e.g., elevators). Thus, BMS systems are a critical component to managing energy demand. Some skilled in the art estimate that improperly configured BMSs may account for up to 20 percent of the energy usage in a given facility. However, energy demand management must be considered along with the primary functions of the BMS system, which is to maintain physical comfort, safety, and efficiency of operations within the facility.

Typically, a BMS is a computer-based control system installed in a facility that controls and monitors the aforementioned subsystems mechanical and electrical equipment such as ventilation, lighting, power systems, fire systems, and security systems. Accordingly, the BMS includes both software and hardware. More often than not, the software is typically proprietary to a given manufacturer, and is provided with interfaces to allow for configuration and access to monitored datapoints.

As one skilled in the art will appreciate, BMSs are complex to design, install, and configure. Errors in the operation of BMSs can occur at multiple points: during installation and initial programming, during upgrades and modification, or as a result of equipment degradation and failures. Additionally, a BMS, while functioning according to its configuration, may not achieve required control and occupant comfort in the most energy efficient manner. For the purposes of this disclosure, the term “occupant comfort” is employed to describe a BMS subsystem or subsystems together functioning in an optimal manner that facilitates the most productive and accommodating environment for the building occupants. In general, when subsystems are functioning according to their original design specifications, occupant comfort will be optimal.

There are a number of systems presently deployed that utilize data generated by a BMS in order to detect and isolate faulty components or subsystems within a facility. Such systems are commonly referred to as automated fault detection (AFD) systems or BMS analytical systems.

A present day AFD system typically processes BMS data non-real time. While this may be sufficient for occasional use, the present inventors have noted that processing data as it is available improves the efficiency and frequency of fault identification for components of subsystems within a facility. Additionally, the present inventors have observed that fault coverage for an AFD may be enhanced when other data, such as meteorological data, site plans, and installer notes are employed in conjunction with BMS-generated data. And while most present day AFD systems either operate manually (e.g., producing graphs of data that must be viewed by a human) or automatically (e.g., producing less accurate fault detection based on so-called “raw” data), the present inventors have noted that utilize both methods to select and execute fault detection algorithms improve fault coverage and fault detection capabilities of an AFD system.

Accordingly, what is needed is a technique for automatically selecting fault detection algorithms for use in an AFD system that employs additional data from multiple sources such as meteorological data, building plans, site survey, and installer notes.

In addition, what is needed is a mechanism for precisely modeling components and subsystems within a facility controlled by a BMS, and for using a predefined set of criteria to define applicability for automatically selecting fault detection algorithms from a tested, prequalified list.

What is further needed is apparatus and methods for generating virtual BMS data for physical points within subsystems for which no data exists by utilizing known characteristics of typical components (e.g., heating coils and fans) to estimate the data.

Moreover, what is needed is a mechanism for normalizing and standardizing BMS generated data to allow for selection of standard fault detection algorithms for use by an AFD system.

### SUMMARY OF THE INVENTION

The present invention, among other applications, is directed to solving the above-noted problems and addresses other problems, disadvantages, and limitations of the prior art.

The present invention provides a superior technique for configuring and executing automated fault detection for components and subsystems of a building management system. In one embodiment, an apparatus is provided for detecting faults of components monitored by a building management system (BMS). The apparatus has an automatic fault detection (AFD) element, coupled to the BMS, configured to monitor, in real time, data samples generated by the BMS indicating operative states of the components, and configured to employ the data samples to determine if one or more of the components are faulty. The AFD element includes a run time modeling element and a fault detection algorithm element. The run time modeling element is configured to employ the data samples and synthesized datapoints as inputs to execute one or more fault algorithms retrieved from a system configuration model, and is configured to generate outputs to the one or more fault algorithms that indicate if the one or more of the components are faulty, where employment of the synthesized datapoints increases fault coverage, resulting in a reduction of false alarms. The fault detection algorithm element is coupled to the system configuration model, and is configured to employ normalized and standardized datapoints representing the data samples and the synthesized datapoints to automatically select the one or more fault algorithms for storage in the system configuration model, where the one or more fault algorithms are selected from a standard fault algorithm data base.

One aspect of the present invention contemplates an apparatus for detecting faults of components. The apparatus includes a building management system (BMS) and an automatic fault detection (AFD) element. The BMS is configured to control and monitor operative states of the components, and is configured to generate data samples of the operative states. The AFD element is coupled to the BMS, and is configured to monitor, in real time, the data samples, and is configured to employ the data samples and synthesized datapoints to determine if one or more of the components are faulty. The AFD element includes a run time modeling element and a fault detection algorithm element. The run time modeling element is configured to employ the data samples and the synthesized datapoints as inputs to execute one or more fault algorithms retrieved from a system configuration model, and is configured to generate outputs to the one or more fault algorithms that indicate if the one or more of the components are faulty, where employment of the synthesized datapoints increases fault coverage, resulting in a reduction of false alarms. The fault detection algorithm element is coupled to the system configuration model, and is configured to employ normalized and standardized datapoints representing the data samples and the synthesized datapoints to automatically select the one or more fault algorithms for storage in the system configuration model, where the one or more fault algorithms are selected from a standard fault algorithm data base.

Another aspect of the present invention comprehends a method for detecting faults of components monitored by a building management system (BMS). The method includes: monitoring, in real time, data samples generated by the BMS indicating operative states of the components, and employing the data samples and synthesized datapoints to determine if one or more of the components are faulty. The monitoring includes: first using the data samples and the synthesized datapoints as inputs to execute one or more fault algorithms retrieved from a system configuration model, and generating outputs to the one or more fault algorithms that indicate if the one or more of the components are faulty, where employing the synthesized datapoints increases fault coverage, resulting in a reduction of false alarms; and second using normalized and standardized datapoints representing the data samples and the synthesized datapoints to automatically select the one or more fault algorithms for storage in the system configuration model, where the one or more fault algorithms are selected from a standard fault algorithm data base.

### BRIEF DESCRIPTION OF THE DRAWINGS

These and other objects, features, and advantages of the present invention will become better understood with regard to the following description, and accompanying drawings where:

FIG. 1 is a block diagram illustrating a present day building management system;

FIG. 2 is a block diagram depicting an automatic fault detection system according to the present invention deployed in association with the building management system of FIG. 1;

FIG. 3 is a block diagram featuring details of the automatic fault detection element of FIG. 2;

FIG. 4 is a block diagram showing input/output interfaces of the input/output interface element of FIG. 3;

FIG. 5 is a flow diagram illustrating a method according to the present invention for generating an initial fault detection configuration for a building management system;

FIG. 6 is a block diagram detailing creation of an exemplary synthesized datapoint according to the present invention;

FIG. 7 is a block diagram depicting creation of an alternative exemplary synthesized datapoint according to the present invention; and

FIG. 8 is a flow diagram featuring a method according to the present invention for fault detection algorithm selection and data point synthesis.

### DETAILED DESCRIPTION

Exemplary and illustrative embodiments of the invention are described below. In the interest of clarity, not all features of an actual implementation are described in this specification, for those skilled in the art will appreciate that in the development of any such actual embodiment, numerous implementation specific decisions are made to achieve specific goals, such as compliance with system-related and business related constraints, which vary from one implementation to another. Furthermore, it will be appreciated that such a development effort might be complex and time-consuming, but would nevertheless be a routine undertaking for those of ordinary skill in the art having the benefit of this disclosure. Various modifications to the preferred embodiment will be apparent to those skilled in the art, and the general principles defined herein may be applied to other embodiments. Therefore, the present invention is not intended to be limited to the particular embodiments shown and described herein, but is to be accorded the widest scope consistent with the principles and novel features herein disclosed.

The present invention will now be described with reference to the attached figures. Various structures, systems, and devices are schematically depicted in the drawings for purposes of explanation only and so as to not obscure the present invention with details that are well known to those skilled in the art. Nevertheless, the attached drawings are included to describe and explain illustrative examples of the present invention. The words and phrases used herein should be understood and interpreted to have a meaning consistent with the understanding of those words and phrases by those skilled in the relevant art. No special definition of a term or phrase (i.e., a definition that is different from the ordinary and customary meaning as understood by those skilled in the art) is intended to be implied by consistent usage of the term or phrase herein. To the extent that a term or phrase is intended to have a special meaning (i.e., a meaning other than that understood by skilled artisans) such a special definition will be expressly set forth in the specification in a definitional manner that directly and unequivocally provides the special definition for the term or phrase.

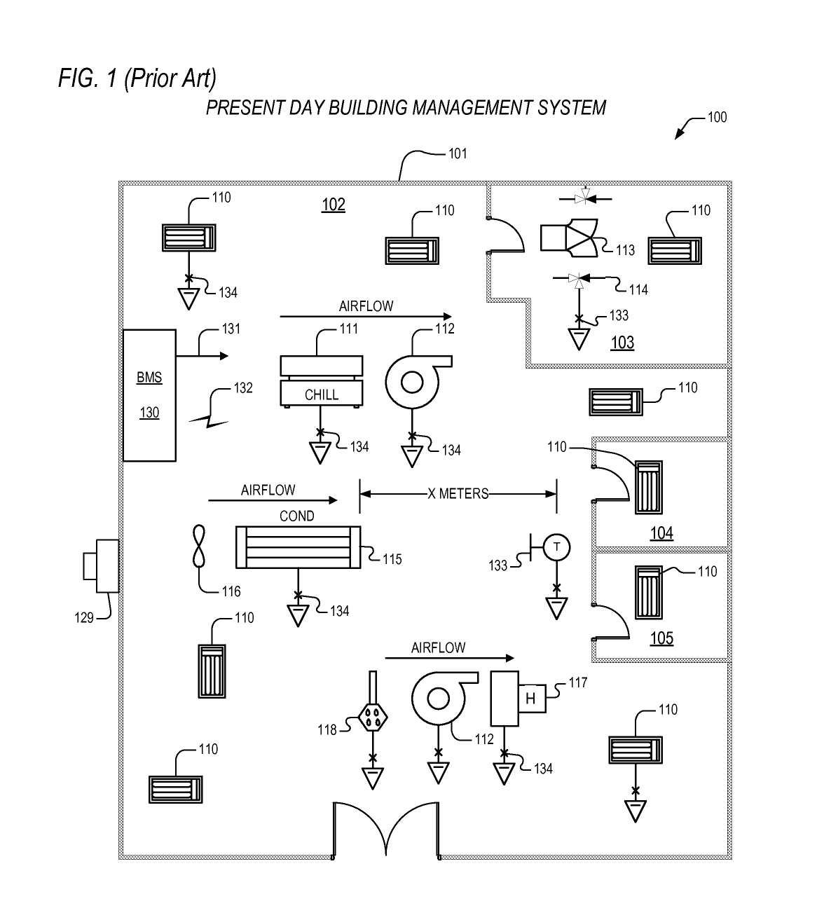

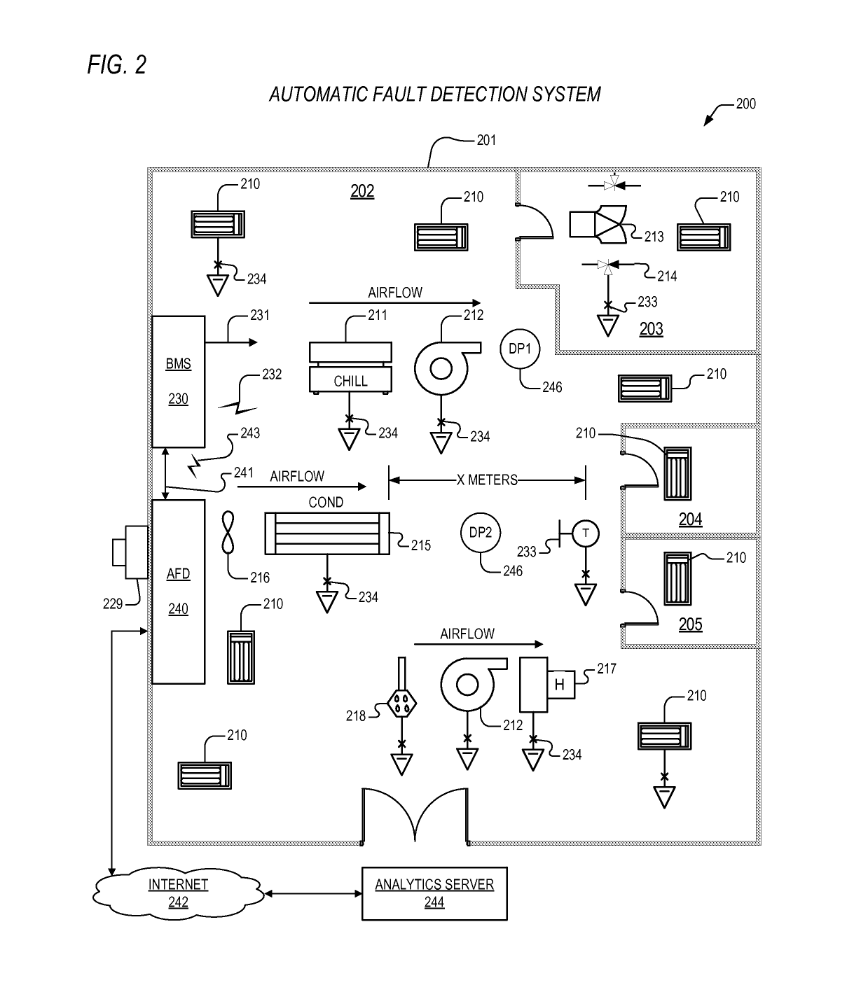

In view of the above background discussion on building management systems and associated techniques employed within present day facilities for the detection of component and system faults therein, a discussion of the disadvantages and limitations of present day fault detection systems will be presented with reference to FIG. 1. Following this, a discussion of the present invention will be presented with reference to FIGS. 2-9. The present invention provides a superior automated fault detection system within a facility administered by a building management system that includes: automatic selection of standard fault detection algorithms, creation and use of virtual datapoints in an automatic fault detection system to improve use of standardized fault detection algorithms and to improve modeling accuracy, reduction of false-positive fault indications (i.e., false alarms) by increasing fault detection algorithm coverage; employing a number of consecutive sensitivity constraints on non-time based filters, and accounting for dropped out data within the fault detection algorithms; and automatic data normalization and standardization in an automated fault detection system.

Turning to FIG. 1, a block diagram 100 is presented illustrating an exemplary present day building management system (BMS). The diagram 100 shows a typical building 101 (or, “facility” 101) that may have a primary space 102 and one or more smaller spaces 103-105 such as offices and the like. Within the facility are heating, ventilation, and air conditioning (HVAC) systems, such as air handlers, chiller plant, boiler plant, terminal units, and the like which are built up from components such as a chiller 111, rotating fans 112, a controllable damper 113, a controllable valves 114, a condenser 115, an axial fan 116, a heater 117, a humidifier 118, and sensors 133-134. There are four physical sensor types, analog inputs/measurements 133, such as temperature, binary inputs 134, such as the actual status of the chiller 111, analog outputs (not shown), such as a speed command sent to a rotating fan 112, and binary outputs (not shown), such as a command on sent to a heater 117. The interior lighting system may also be tied into the BMS 130 so, in addition to the HVAC components are lighting fixtures 110. The facility 101 may also be provided with energy sources including, but not limited to, electricity, water, and natural gas that are metered at a single meter point or at sub points throughout the facility 101. For clarity purposes, these metered points are represented in the diagram 100 as a single energy consumption meter 129. The lights 110 and HVAC components 111-118 are distributed throughout the spaces 102-105 within the facility 101 to provide for, among other objectives, occupant comfort, occupant productivity, and security. As is alluded to above, there are numerous other components that may be present within a facility such as plumbing, access control equipment, video surveillance equipment, and special purpose industrial control systems, but although a discussion of such components are beyond the scope of the present disclosure, the present inventors note that one skilled in the art will be enabled by the present disclosure to adapt the present invention to any building management system component that is not specifically addressed herein.

For purposes of discussion, consider that a typical BMS element 130 is deployed to provide for monitoring and control of the BMS components 110-118 within the facility 101. That is, most of the components 110-118 shown in the diagram 100 allow for control by the BMS element 130 over one or more wired links 131 or wireless links 132. Further consider that some of the components 110-118 may include a sensor feedback point 120 that allows the BMS element 130 to determine if a corresponding BMS component 110-119 is in an operational status as has been directed by the BMS element 130. The corresponding sensor feedback points 133 and 134 may be coupled to the BMS element 130 via one or more conventional wired links 131 and/or wireless links 132.

Operationally, the BMS element 130 may be programmed to change the operational status of each of the BMS components 110-118, respectively or in combination, throughout a scheduled period of time, in order to achieve a desired level of comfort, productivity, security, and the like. Sensors 133-134 throughout the facility 101 will be accessed periodically, according to programming of the BMS element 130, in order to determine that commands to certain components 110-118 have been actually received by the components 110-119 and carried out accordingly. For example, throughout the scheduled period the BMS element 130 may periodically gather temperature information regarding the facility from one or more temperature sensors 133 and may in response actuate the chiller 111, the corresponding rotational fan 112, the condenser 115, and its corresponding axial fan 116 to promote cooling of the facility 101. In concert, the BMS element 130 may also open controllable dampers 113 within one of the smaller rooms 103 to promote cooling as well. During other periods, the BMS element 130 may actuate the heater 117, the humidifier 118, and corresponding rotational fan 112 to provide for heating of the facility 101. Similarly, one or more of the lights 110 may be dimmed or turned off to provide for energy reduction during a demand response management event.

The scenarios for control and monitoring of BMS components, such as the ones 110-118, 133-136 shown in the exemplary facility 101, are limitless. However, it has been noted by the present inventors that though many present day BMS elements 130 provide programming to monitor the operational status of their corresponding BMS components 110-118, the algorithms that are employed to determine status and faults are not necessarily suited to provide sufficient coverage for comprehensive fault detection. More specifically, the present inventors have observed that virtually all present day BMS elements 130 utilize sensor feedback points 133 and 134 that directly correspond to a BMS component 110-118 to determine if that component 110-118 is functioning as directed with little regard to the programmed control sequences. In addition, it has been noted that the sensed states of the components is all that is employed to determine whether those components are operating correctly or not, and there is not data provided as to whether a system of components, such as the rotating fan 112, condenser 115, and chiller 111, together are functioning in an optimal state. For illustrative purposes, a temperature sensor 133 is shown as being deployed after the condenser 115 and prior to the rotating fan 112, in terms of airflow direction. Most conventional BMS elements 130 may only utilize feedback of operational status from the condenser sensor feedback point 134 to determine that state of the condenser 115, irrespective to the order of the components 112, 115, and 133 and to whether they are operating optimally.

The present inventors note that, in order to provide a building owner/manager with useful tools to manage, monitor, and correct facility errors and inefficiencies, various techniques have been developed in recent years, often referred to as fault detection techniques, automated fault detection (AFD) techniques, and BMS analytics. Such techniques will be henceforth referred to as AFD techniques within the present disclosure. AFD techniques employ various analytical methods to examine operational logs generated by the BMS element 130 and other energy data in order to identify the components 110-118 responsible for any negative changes in operation.

A present day AFD system typically performs the steps exemplified by the following flow to perform AFD analyses: Operational data is gathered, either manually or via a software interface to the BMS element 130. Then rules and equations to evaluate the BMS components 110-118 are created, generally by a manual process. Finally, an AFD output is generated that presents detected anomalies in an appropriate format. The rule sets and equations are typically predefined to apply to all BMS components of a particular component type (e.g., fan or chiller) without regard to configuration placement within the facility 101 or other differentiating criteria such as manufacturer, capacity, and the like.

Accordingly, the present invention overcomes the above noted disadvantages and limitations, and others, associated with present day building management systems, by providing mechanisms for automated fault detection system within a facility administered by a building management system. The automated fault detection system provides for automatic selection of standard fault detection algorithms and creation and use of virtual datapoints to improve use of standardized fault detection algorithms and to improve modeling accuracy. The automated fault detection system also provides for reduction of false-positive fault indications (i.e., false alarms) by increasing fault detection algorithm coverage, employing a number of consecutive sensitivity constraints on non-time based filters, and accounting for dropped out data within the fault detection algorithms, and automatic data normalization.

The present invention advances the current art by enabling selection of standardized, tested, and approved sets of fault detection algorithms based on configuration within a facility, component layout and function, system type, and physical characteristics of a facility. At a detailed level, the present inventors have analyzed various building systems which are typically controlled and monitored by a BMS element 130. Consider for example analyzing a single air handler within a facility. Fault detection algorithm selection according to the present invention is based on an air handler type, components present, and the layout/arrangement of these components within the system, and the sequence of operations (i.e., how the components are programmed to function). The present invention additionally utilizes system interactions, such as terminal units feedback to control resets for air handlers, and air handlers feedback to control resets for a chiller plant and/or boiler plant, when selecting fault detection algorithms; this information is taken in as part of the sequence of operations.

In one aspect of the present invention, the AFD system more completely models a facility through inclusion of physical environmental data by utilizing synthesized data points; maintaining awareness of the quality, validity, type, and relative value of data being utilized for analysis; maintaining awareness of the operational state of each BMS component (e.g., on, off, idle, active, failed, etc.) to reduced false fault indications; and generating additional valuable output useful for not only diagnosing faults, but also improving the operational aspects of the facility.

The AFD system according to the present invention enables the processing of data from additional data sources such as, but not limited to, geographic data, building plans, installer notes, and site surveys, thus improving the opportunity to identify faults that cannot be otherwise identified using only data provided by the BMS element 130.

Another improvement according to the present invention over prior AFD systems is the combined interactive use of both automated and manual fault identification methods. While most AFD systems either operate manually (e.g., producing graphs of data that must be viewed by a human) or automatically (e.g., producing less accurate fault detection based on so-called “raw” data, which means less manipulated data), the present invention utilizes both methods to improve fault detection. Another feature of the present invention is the utilization of information about a system's component configuration, cause and validity of a detected fault, and detailed information about the facility to both improve the standard number and breadth of fault detection algorithms, as well as the ability of the AFD system according to the present invention to learn from erroneously identified faults (vi a feedback) in order to improve future performance.

Another improvement according to the present invention over prior AFD systems is the ability to more completely identify various data sources, data types, and “tag” or otherwise uniquely identify the data using additional metadata. By “tagging” input data, each data field can be normalized both in type and temporal quality, such that the AFD system according to the present invention makes a more accurate determination of faults, while eliminating false errors induced by unaligned data or inappropriately scaled data.

Another improvement over prior AFD systems is that the present invention more accurately represents (or “models”) the complex behavior of a facility. By including additional data fields such as meteorological data, occupancy levels, BMS maintenance personnel notes, etc, the system can gain a more complete understanding of the facility that would be otherwise impossible by exclusively modeling only the operation of physical devices in the modeled facility. This is accomplished through sequences of operations driven fault detection algorithms that are specific to component arrangement and settings tolerance.

Present day AFD systems focus primarily on identifying faults of equipment or programming of a facility BMS, and the present inventors note that an important aspect of the present invention is the improved ability to identify the base energy consumption “footprint” of a building through building level metering and system sub-meters (if available), and to utilize this information in order to produce actionable steps toward reducing energy use and improving occupant comfort of the facility. This information is utilized to reprogram an existing BMS element, as well as to provide a path for viable improvements to a facility that will reduce energy use and cost. The ability to generate actionable, efficient steps toward improving a facility distinguishes the present invention from simpler AFD systems that focus exclusively on providing graphs or tables of potentially failing devices.

Referring now to FIG. 2, a block diagram 200 is presented depicting an automatic fault detection system according to the present invention deployed in association with the building management system of FIG. 1. Like the diagram 100 of FIG. 1, the diagram 200 includes a typical facility 201 that may have a primary space 202 and one or more smaller spaces 203-205 such as offices and the like. Within the facility are heating, ventilation, and air conditioning (HVAC) systems, such as air handlers, chiller plant, boiler plant, terminal units, and the like which are built up from components such as a chiller 211, a rotating fans 212, controllable dampers 213, controllable valves 214, condenser 215, axial fans 216, heaters 217, humidifiers 218, and sensors. There are four sensor types: analog inputs/measurements 233 such as temperature, binary inputs 234 such as the actual status of chiller, analog outputs (not shown) such as speed command sent to a rotating fan, and binary outputs (not shown) such as a command to enable a heater. The interior lighting system may also be tied into the BMS so in addition to the HVAC components are lighting fixtures 210. The facility 201 may also be provided with energy sources including, but not limited to, electricity, water, and natural gas that are metered at a single meter point or at sub points throughout the facility 201. For clarity purposes, these metered points are represented in the diagram 200 as a single energy consumption meter 229. The lights 210 and HVAC components 211-218 are distributed throughout the spaces 202-205 within the facility 201 to provide for, among other objectives, occupant comfort, occupant productivity, and security. As is alluded to above, there are numerous other components that may be present within a facility such as plumbing, access control equipment, video surveillance equipment, and special purpose industrial control systems.

Like the system of FIG. 1, consider that a typical BMS element 230 is deployed to provide for monitoring and control of the BMS components 210-218 within the facility 201. That is, most of the components 210-218 shown in the diagram 200 allow for control by the BMS element 230 over one or more wired links 231 or wireless links 232. Further consider that some of the components 210-218 may include a sensor feedback point 233 and 234 that allows the BMS element 230 to determine if a corresponding BMS component 200-218 is in an operational status as has been directed by the BMS element 230. The corresponding sensor feedback points 233 and 234 may be coupled to the BMS element 230 via the one or more conventional wired links 231 and/or wireless links 232.

Operationally, the BMS element 230 may be programmed to change the operational status of each of the BMS components 210-218, respectively or in combination, throughout a scheduled period of time, in order to achieve a desired level of comfort, productivity, security, and the like. Sensors 233 and 234 throughout the facility 201 will be accessed periodically, according to programming of the BMS element 230, in order to determine that commands 235 and 236 to certain components 210-218 have been actually received by the components 210-218 and carried out accordingly.

However, in contrast to the facility 101 of FIG. 1, the facility 201 according to the present invention also includes an automated fault detection (AFD) element 240 that is coupled to the BMS element 230 via a wired link 231 and/or a wireless link 232, and that is also coupled to the energy consumption meter 329. In one embodiment, the AFD element 240 may be collocated with the BMS element 230. The AFD element 240 is also coupled to an analytics server 244 over a wide area network 242 such as the well-known internet 242 by well-known mechanisms of connection. In one embodiment, the AFD element 240 is configured to analyze real-time operational data that is generated by the BMS component 230 according to the processes described herein, along with additional data obtained from the analytics server 244 and the energy consumption meter 229 to provide for more comprehensive fault coverage and detection of components 210-218 within the facility 201.

In one embodiment, the AFD element 240 may comprise a general purpose central processing unit and memory within which are disposed one or more application programs that are configured to perform the AFD functions described herein. Other embodiments many comprise a combination of dedicated hardware and software that are configured to perform the functions described herein. In one embodiment, the AFD element 240 may share hardware and/or software resources with the BMS element 230. Alternative embodiments may comprise specific input/output interfaces that are configured to intercommunicate with both a specific BMS element 230 and the analytics server 244. In a further embodiment, the AFD element 240 may be disposed within the analytics server 244.

The AFD element 240 may be configured prior to real-time operation with “tagged” data describing the arrangement of system components for the systems within facility 201, along with sequence of operations and other system operational information. Such data may include, but is not limited to, the make and model information of the BMS components 210-218 disposed therein, the order in which the components 210-218 are disposed (e.g., humidifier 218 first, followed by rotating fan 212, followed by heater 217), the locations and associations of sensor feedback points 233 and 234, the locations of sensor elements 233 relative to BMS subsystems with which the sensors provide for optimal operations feedback (e.g., temperature sensor 233 is found after the condenser 215 prior to the heater 217), interactions among components of a BMS subsystem, and other data that may further facilitate automatic selection of fault detection algorithms, creation of synthesized data points, reduction of false alarms through refinement of selected fault algorithms, employing number of consecutive sensitivity constraints on non-time based filters, and accounting for dropped out data within the fault detection algorithms, and normalization and standardization of BMS data within the facility. One important aspect of the invention is that it is fully pre-programmed and only requires configuration applicable to the systems on which it is deployed, which is accomplished through configuration menus.

During real-time operation, the AFD element 240 will gather BMS status data from the BMS element 230, energy consumption data from the meter 229, and various other data described above, as required, from the analytics server 244 in order to achieve the functions noted herein. The AFD element 240 may generate one or more reports comprising, but not limited to, detected fault data, corrective action data, and efficiency improvements data. These reports may be communicated via direct display on the AFD element 240 or may be transmitted to the analytics server 244.

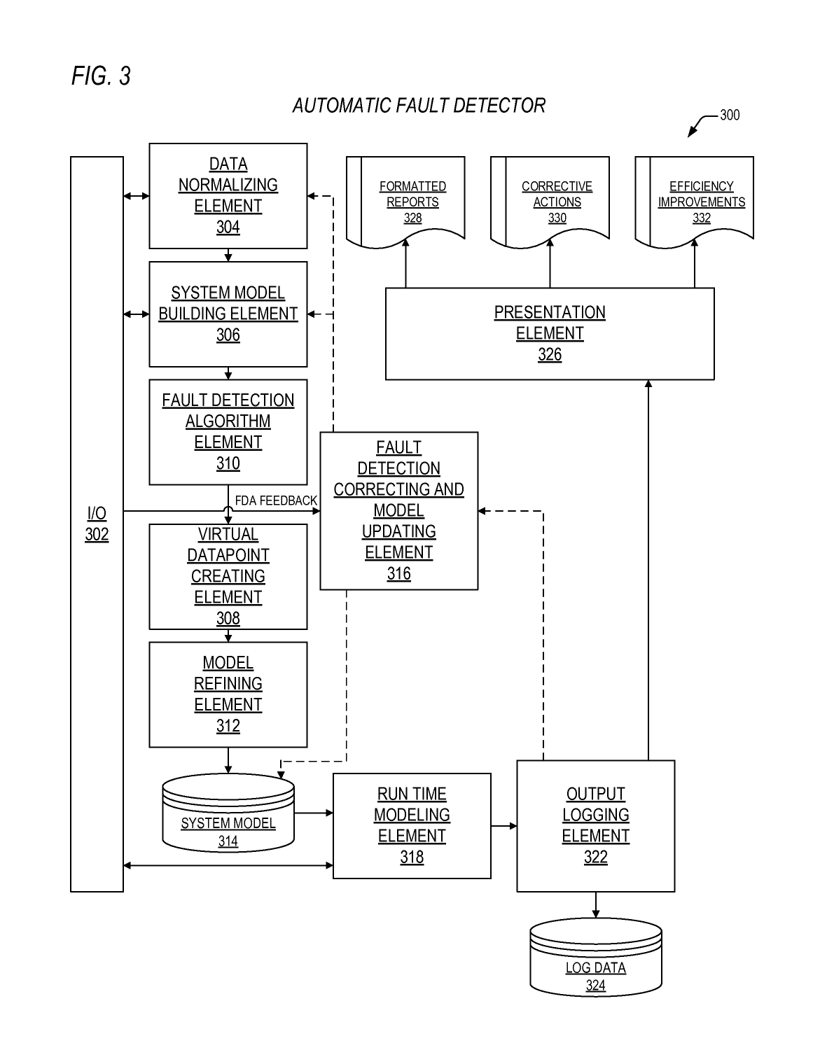

Turning also now to FIG. 3, a block diagram 300 is presented featuring details of the AFD element 240 of FIG. 2. The AFD element 240 an input/output (I/O) interface 302 that is coupled to a data normalizing element 304, a system model building element 306, a fault detection correcting and model updating element 316, and a run-time modeling element 318. The data normalizing element 304 is also coupled to the system model building element 306 and to a fault detection algorithm element 310. The fault detection algorithm element 310 is coupled to a virtual datapoint creating element 308, which is coupled to a model refining element 312. The model refining element 312 is coupled to a system model data base 314 and optionally, in an iterative embodiment, to the virtual data point creating element 308 (via bus 313). The fault detection correcting and model updating element 316 is coupled to a run time modeling element 318, which is coupled to the system model data base 314, a system configuration data base 320, and an output logging element 322. The output logging element 322 is coupled to a log data base 324, a presentation element 326, and the fault detection correcting and model updating element 316. The presentation element 326 may generate formatted reports 328, corrective actions 330, and efficiency improvements 332.

In operation, configuration of a facility model may begin via the I/O element 302 with selection and consolidation of various data sources available. These sources may include structured electronic data, such as that available from the BMS element 230. The data may also include unstructured and non-electronic information such as scanned architectural drawings retrieved from the analytics server 244. Such data may also be combined with other data sources provided via the analytics server 244, some electronic and some manual, such as notes from BMS configuration and programming teams, photographs of equipment placement, and setup and notes from site surveys and inspections. Electronic sources may be incorporated automatically or by personnel by selecting the appropriate input data selection method, and selecting the data to be imported. Manual sources are added by selecting the function, data type, and other appropriate criteria from pull-down lists that may be displayed and controlled at either the AFD element 240 or the analytics server 244. Additional data may also be obtained from private and public data sources such as satellite and aerial photographs, meteorological data, building orientation, and utility energy consumption records.

The data normalizing element 304 performs functions required to capture each type of data in the BMS system and to store the required equations used to normalize the data, along with the properties defined for each data element to assign an appropriate point code. “Point code,” as used herein, is a term that describes a short name used by filter algorithms within the AFD element 240 to reference the data point (e.g., a supply air duct static pressure sensor data is given a point code of “SA_SPres_AI”). Data extracted from the various sources noted above may be consolidated and normalized as to data type, size, range, accuracy, resolution, engineering units, and any needed correction factors. This data is assigned to an appropriate location within a hierarchical model within the system model building element 306. The hierarchical model may reflect sensor location, type, and function, resulting in assignment of a point code to the data. The present inventors note that data normalization and standardization is an important part of the configuration process according to the present invention, since normalization and standardization enables use of standardized fault detection algorithms from a fault equation database (not shown).

As noted above, the system model building element 306 creates a hierarchical order of the components, equipment, and subsystems within the facility 201. The hierarchical ordering is employed all the way down to each subsystem, laying out the system type and component hierarchy for each system. This feeds into the fault detection algorithm element 310, which selects from a standard set of fault detection algorithms those required for coverage in the facility 201, which results in the development of an initial system model having a list of all the potential filter algorithms that can be applied to the modeled system if all the potential data points existed. The system model is used to represent the subsystems in the BMS, the components within each subsystem, the connectivity and relation between components in the BMS and components within the subsystems, the location of those devices within the facility 201, and the operational programming for each component of each subsystem. For example, each room 202-205 in the facility 201 may have similar components 210-218 and sensors 233 and 234 that monitor temperature, light, airflow, status, and commands that control air dampers, fans, and heating elements. These components 210-218, however, will function differently depending on the type and location of windows, heat load from sunlight, and differing levels of occupancy. Representing each component 210-218 in the precise sequential process aligned to its spatially correct placement improves the AFD system's detection accuracy through improved algorithm selection.

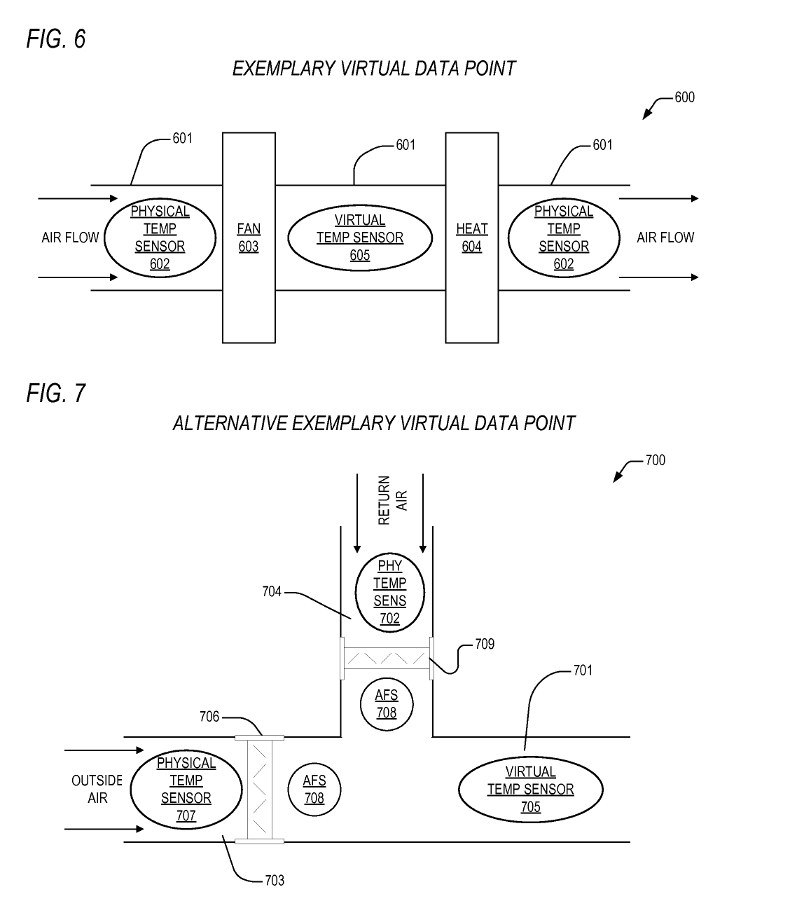

The next step is the creation of “virtual datapoints” 246, which is performed by the virtual data point creating element 308 in order to improve fault detection capabilities. Virtual datapoints 246 are points of measurement that do not exist physically, but which can be accurately modeled based on the known configuration and physical parameters of both the BMS components 210-218 and the arrangement of the components 210-218. These virtual datapoints 246 greatly increase the list of usable fault detection algorithms, and, as a result of this increase fault detection coverage, false-positive indications (i.e., false alarms) are greatly reduced during run time. This data is utilized by the model refining element 312, which reduces the initial system model down to the final system model which consists of the runnable algorithms list, i.e., a finalized list of all algorithms that can be executed. Only algorithms that have all required data points available within the system model are executed. For example, if an algorithm requires point codes A, B, and C, and C is a real data point collected from the BMS element 230, and A is a data point created in virtual point creation, but C doesn't exist and couldn't be created through point creation, the potential algorithm is removed from the runnable list. Utilization of standardized fault detection algorithms is a distinct and substantial advantage of the present invention over prior art. In prior art AFD systems, fault detection algorithms are either written manually for each unique system configuration or a lesser set of generalized set of fault detection algorithms are applied regardless of system configuration. According to the present invention, however, fault detection algorithms are selected from a centrally maintained and commissioned list of standardized and tested algorithms, reducing the possibility of error, while also greatly improving the speed, accuracy, and completeness of AFD system configuration process. Specific virtual datapoints 246 will be more particularly discussed herein below, with reference to FIGS. 6-7. The present inventors note that the creation of virtual data points 246 according to the present invention represent a marked improvement over prior art AFD systems, since they enable the use of a wider variety of standardized fault detection algorithms.

The model refining element 312 utilizes the initially created system model, the normalized and standardized data, and the virtual datapoints 246 to yield a base system model that is stored, along with all appropriate configuration parameters, in the system model data base 314. The system model includes a dataset of fault detection algorithms that will be used by the AFD element 240 to evaluate the component data provided by the facility's BMS element 230.

The run time modeling element 318 uses the base system model stored within the system model data base 314 and other information from the I/O element 302. The data output from the run time modeling element 318 is passed to the output logging element 322, which processes and sends the data along for further processing and analysis within the presentation element 326 and for storage in the log data base 324. The process is an iterative embodiment, the output logging element feeds into the fault detection correcting and model updating element 316, which also takes into account personnel-provided information. If system model improvements or corrections are identified, model adjustments can be initiated automatically through updates to the data normalizing element 304, system model building element 306, and/or the system model data base 314, which typically involves associated configuration parameters. The feedback may be provided at the AFD component 240 itself or via the I/O interface 302 based upon data transmitted from the analytics server 244.

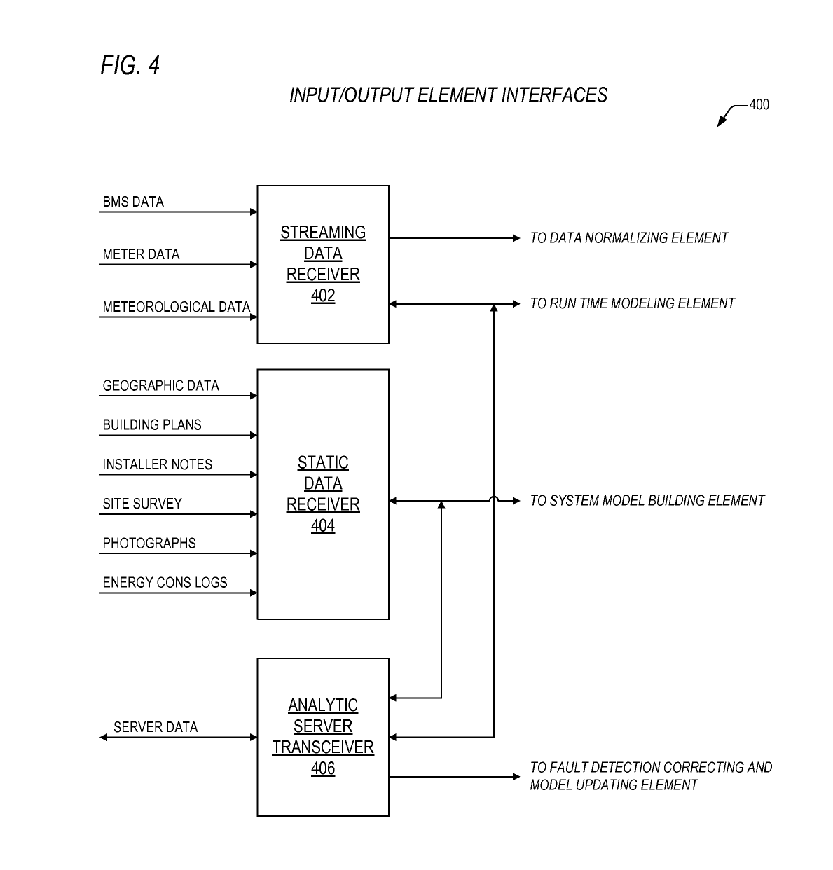

Referencing FIG. 4, a block diagram 400 is presented showing input/output interfaces of the input/output interface element 302 of FIG. 3. The diagram 400 depicts a streaming data receiver 402 that receives streaming data such as, but not limited to data from the BMS element 230, data from the meter 229, and meteorological data that may be provided via the analytics server 244. The diagram 400 also shows a static data receiver 404 that is configured to receive static data such as, but not limited to, geographic data, building plans, installer notes, site surveys, photographs, and energy consumption logs, maintained for system configuration documentation purposes. The diagram 400 further depicts an analytic server transceiver 406 that is coupled to both the streaming data receiver 402 and the static data receiver 404. The analytic server transceiver 406 additionally provides data to the run time modeling element 318, the system model building element 306, and the fault detection correcting and model updating element 316.

In operation, streaming data is provided to the streaming data element 402 from both the BMS element 230 and the analytics server 244. Static data is provided via the analytics server 244. The streaming and static data is employed by the AFD element 240 as is herein described to provide for a fault detection system that includes automatic selection of fault detection algorithms, synthesis of virtual datapoints, reduction of false alarms via an increase and overlap of fault detection coverage, employing number of consecutive sensitivity constraints on non-time based filters, and accounting for dropped out data within the fault detection algorithms, and normalization and standardization of BMS component data.

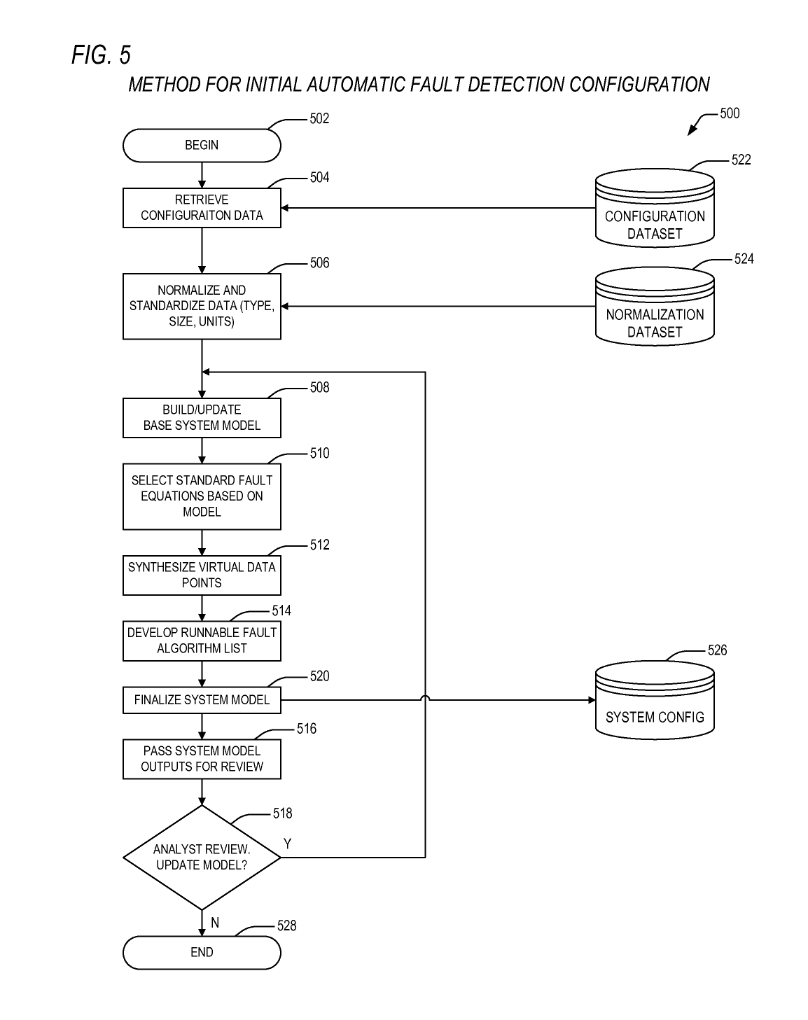

Referring to FIG. 5, a flow diagram 500 is presented illustrating a method according to the present invention for generating an initial fault detection configuration for a building management system. Flow begins at block 502, where initial selection of fault detection algorithms is begun for a described facility, such as the facility 201 of FIG. 2. Flow then proceeds to block 504.

At block 504, configuration data for the facility is retrieved from a configuration data set 522. The configuration data set 522 may include a diverse set of data from multiple manual and electronic sources, as described above. Flow then proceeds to block 506.

At block 506, the retrieved data is then normalized and standardized so that it can be used to automatically select fault equations from a library of predefined equations. Flow then proceeds to block 508.

At block 508, a base system model is generated utilizing the normalized and standardized data provided via block 506 and other configuration data via block 504. The base system model represents the BMS components 210-218 within the facility 201 under evaluation. In a non-iterative embodiment the base system model is built in a single pass. In an iterative embodiment, the base system model is initially built, and then updated as required based upon review in block 518. In both embodiments, should additional data be provided via the I/O interface 302, the process of generating a base system model will start anew. Flow then proceeds to block 510.

At block 510, standard fault equations are selected for the base system model generated at block 508. Flow then proceeds to block 512.

At block 512, one or more virtual datapoints are automatically created to supplement the base system model as a function of missing datapoints, available datapoints, and component arrangement. The synthesis of virtual data points allows for maximum fault algorithm coverage. Flow then proceeds to block 514.

At block 514, the runnable fault algorithm list is developed from the base/updated system model. Then flow proceeds to block 520.

At block 520, a final system model is verified and stored in a system configuration data base 526. Normalization equations for the data are also stored in the system configuration data base 526. The data stored in the system configuration data base 526 is the data employed by the AFD element 240 to process BMS component data during real-time operation. As is noted above, the system model can be updated with additional information or changes to current data inputs, which will initiate re-creation of the initial system model. Flow then proceeds to block 516, where the final system model generates outputs.

At block 516, final system model outputs are passed for review. Flow then proceeds to decision block 518.

At decision block 518, a review determines if the model requires updating. If so, then flow then proceeds to block 508 where the system model is updated based upon feedback. Otherwise, no update is required and the flow proceeds to block 528, where the method completes.

At block 520, a final system model is verified and stored in a system configuration data base 526. Normalization equations for the data are also stored in the system configuration data base 526. The data stored in the system configuration data base 526 is the data employed by the AFD element 240 to process BMS component data during real-time operation. As is noted above, the system model can be updated with additional information or changes to current data inputs, which will initiate re-creation of the initial system model. Flow then proceeds to block 528, where the method completes.

Referring to FIG. 6, a block diagram 600 is presented detailing creation of an exemplary synthesized datapoint according to the present invention, as may be created by the AFD element 240 of FIG. 2 via the method described with reference to FIG. 5.

Consider an air plenum 601 that contains a heater 604, a fan 603 that precedes the heater 604 with regard to direction of air flow, a temperature sensor 602 preceding the fan 603, and a temperature sensor 602 that follows the heater 604. Measurement of the temperature directly after the fan 603 and before the heating element 604 may be desired by a selected standardized fault detection algorithm according to the present invention. Such a temperature measurement may be required to improved fault coverage by enabling detection of a leaking heating valve (not shown) for example, but no such physical measuring point exists. There are temperature sensors 602 prior to the fan 603 and at the air outlet from the plenum 601, however. Accordingly, the AFD element 240 according to the present invention models the temperature change across the fan 603 along with its airflow calculated using fan speed, thus enabling the AFD element 240 to estimate the temperature at a synthesized datapoint 605 at the discharge from the fan 603 and prior to the heating coil 604. This virtual point 605 is used to augment the selection of fault detection algorithms that might otherwise be impossible without the required measuring point 605, in order to detect a faulty valve that is leaking when it is closed. The datapoint 605 represents the calculated temperature value based on thermodynamic principles at that point in the plenum 601, having been modeled by the system model building element 306. Although this is a simplified example, one skilled in the art can understand that complex environments can be accurately modeled in software, and that this modeling capability generates substantial advantage in both fault detection capabilities as well as improved capability to utilize standardized fault detection algorithms.

Attention is now directed to FIG. 7, where a block diagram 700 is presented illustrating creation of an alternative synthesized datapoint accordingly to the present invention. In this example, a mixing plenum 701 is coupled to outside air plenum 703 and return air plenum 704. A first temperature sensor 707 is disposed within outside air plenum 703 to measure outside air temperature preceding a first controllable damper 706, and a second temperature sensor 702 is disposed within return air plenum 704 to measure return air temperature preceding a second controllable damper 709. Plenums 703-704 also have airflow sensors 708 for measuring airflow with regard to direction of airflow. Measurement of the temperature directly after the mixing of the two air plenums 703 and 704 is desired by a selected standardized fault detection algorithm according to the present invention to, say, enable detection of an economizer damper reacting improperly to building conditions relative to the outside air conditions. There are temperature sensors 702 and 707 prior to the mixing of the two air plenums 703 and 704 and airflow rates corresponding to plenums 703-704 are provided by sensors 708. Accordingly, the AFD element 240 according to the present invention employs plenum temperatures provided by sensors 702 and 707, along with the individual airflow rates provided by sensors 708, to estimate the temperature at a synthesized datapoint 705 after the mixing of the two air plenums 703-704 within the combined plenum space 701. As in the example of FIG. 6, this virtual point 705 is used to augment the selection of fault detection algorithms that might otherwise be impossible without the required measuring point 705. The datapoint 705 represents the calculated temperature value based on thermodynamic principles at that point in the plenum 701, having been modeled by the system model building element 306.

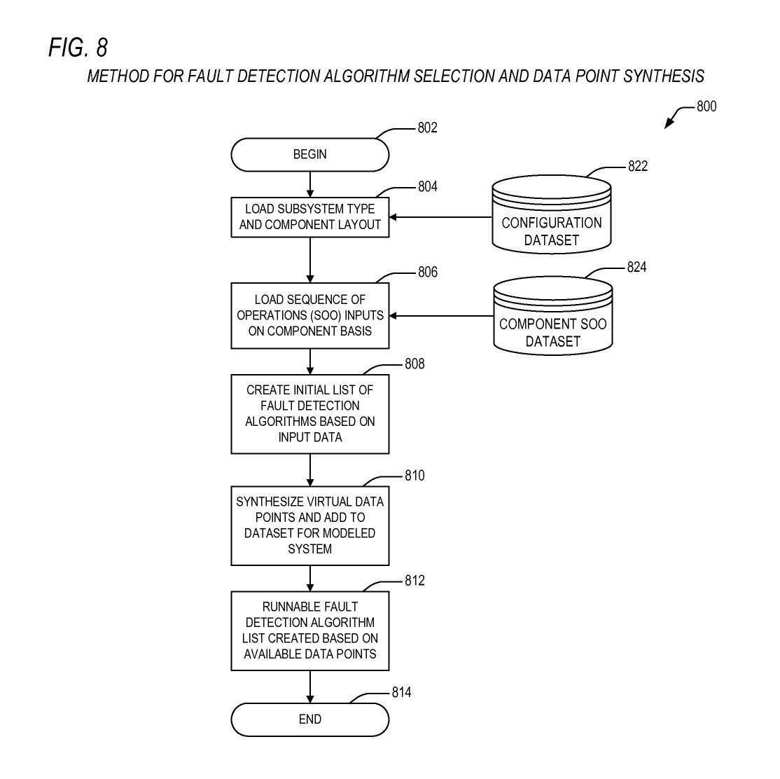

Now referring to FIG. 8, a flow diagram 800 is presented featuring a method according to the present invention for fault detection algorithm selection and data point synthesis. The diagram 800 represents the steps taken during configuration of the AFD component 240 in order to select the optimal number and type of fault algorithms. The process of steps shown is iterative and occurs for each set of related components within the BMS. BMS subsystems are often quite complex, and the relationships between components and subsystems may be overlapping. Thus, the present invention provides for a hierarchy of component relationships where each set in the hierarchy is represented by unique sets of fault detection algorithms, allowing for overlap and improvement of fault detection capabilities. Further, one or more BMS component may operate in multiple related sets, and, therefore, be represented multiple times, once for each set.

Flow begins at block 802, where it is desired to select fault algorithms for the facility 201. Flow then proceeds to block 804.

At block 804, a subsystem is selected having interrelated components within the facility 201 and pertinent related and required data is learned through a directed menu driven user inputs. A configuration data set 822 is accessed to load the subsystem type and layout of components therein. Flow then proceeds to block 806.

At block 806, the AFD component 240 accesses a component sequence of operations (SOO) data set 824 to load SOO inputs for each component within the selected subsystem through a directed menu driven user input unique to that subsystem. Flow then proceeds to block 808.

At block 808, an initial list of standardized fault detection algorithms is automatically selected for the subsystem base on the SOO inputs obtained. Flow then proceeds to block 810.

At block 810, any datapoints that are not physically available are synthesized automatically where possible and using similar techniques as is described above. Flow then proceeds to block 812.

At block 812, any fault detection algorithms which were selected, but for which required datapoints may not be available, are discarded and a runnable list of applied fault detection algorithms is generated and added to the system configuration 822. The applied algorithms list directs the necessary user applied parameter inputs. Flow then proceeds to block 814.

At block 814, the method completes.

To summarize, based on the selected subsystem configuration and sequence of operations data inputs, the AFD component 240 creates a potential filter list, which is a list of all the filters that can executed for the facility 201 being modeled, providing that all required datapoints exist in the facility 201. After creation of the virtual datapoints is complete and added to the system configuration dataset, the runnable filter list is created, which is a list of all the filters that can be executed based on the real datapoints coming in from the BMS component 230 and the synthesized datapoints. If an algorithm requires a datapoint that does not exist and could not be synthesized, then the filter cannot be executed and it is removed from the runnable filter list.

Following the process of FIG. 8, a list of the synthesized datapoints and the datapoints used in their creation is forwarded to an analyst for evaluation, which may lead to updates to the system model, and which will trigger the re-creation of the potential filter algorithm list, virtual datapoints, and runnable algorithm list.

The AFD component 240 according to the present invention is configured to perform the functions and operations as discussed above. The AFD component 240 may comprise logic, circuits, devices, or application programs, or a combination of logic, circuits, devices, or application programs, or equivalent elements that are employed to execute the functions and operations according to the present invention as noted. The elements employed to accomplish these operations and functions within the AFD component 240 may be shared with other circuits, application programs, etc., that are employed to perform other functions and/or operations within the AFD component 240. According to the scope of the present application, application program is a term employed to refer to a plurality of instructions executable by one or more CPUs.

Portions of the present invention and corresponding detailed description are presented in terms of software, or algorithms and symbolic representations of operations on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, or as is apparent from the discussion, terms such as “processing” or “computing” or “calculating” or “determining” or “displaying” or the like, refer to the action and processes of a computer system, a microprocessor, a central processing unit, or similar electronic computing device, that manipulates and transforms data represented as physical, electronic quantities within the computer system's registers and memories into other data similarly represented as physical quantities within the computer system memories or registers or other such information storage, transmission or display devices.

Note also that the software implemented aspects of the invention are typically encoded on some form of program storage medium or implemented over some type of transmission medium. The program storage medium may be electronic (e.g., read only memory, flash read only memory, electrically programmable read only memory), random access memory magnetic (e.g., a floppy disk or a hard drive) or optical (e.g., a compact disk read only memory, or “CD ROM”), and may be read only or random access. Similarly, the transmission medium may be metal traces, twisted wire pairs, coaxial cable, optical fiber, or some other suitable transmission medium known to the art. The invention is not limited by these aspects of any given implementation.

The particular embodiments disclosed above are illustrative only, and those skilled in the art will appreciate that they can readily use the disclosed conception and specific embodiments as a basis for designing or modifying other structures for carrying out the same purposes of the present invention, and that various changes, substitutions and alterations can be made herein without departing from the scope of the invention as set forth by the appended claims.

What is claimed is:

1. An apparatus for detecting faults of components monitored by a building management system (BMS), the apparatus comprising:
an automatic fault detection (AFD) element, coupled to the BMS, configured to monitor, in real time, data samples generated by the BMS indicating operative states of the components, and configured to employ said data samples to determine if one or more of the components are faulty, said AFD element comprising:
a run time modeling element, configured to employ said data samples and synthesized datapoints as inputs to execute one or more fault algorithms retrieved from a system configuration model, and configured to generate outputs to said one or more fault algorithms that indicate if said one or more of the components are faulty, wherein employment of said synthesized datapoints increases fault coverage, resulting in a reduction of false alarms; and
a fault detection algorithm element, coupled to said system configuration model, configured to employ normalized and standardized datapoints representing said data samples and said synthesized datapoints to automatically select said one or more fault algorithms for storage in said system configuration model, wherein said one or more fault algorithms are selected from a standard fault algorithm data base.

2. The apparatus as recited in claim 1, wherein said AFD element is also coupled to one or more energy consumption meters, and wherein said run time modeling element additionally employs energy consumption data generated by said one or more energy consumption meters as inputs to said one or more fault algorithms.

3. The apparatus as recited in claim 2, wherein said AFD element is coupled to an analytics server, and wherein said analytics server is configured to provide additional data for use by said fault detection algorithm element in selection of said one or more fault algorithms.

4. The apparatus as recited in claim 3, wherein said additional data comprises meteorological data, a building plan, a site survey, or installer notes.

5. The apparatus as recited in claim 1, wherein said system configuration model comprises one or more subsystems of related ones of the components, and wherein said related ones of the components are tagged according to type, size, and relative location.

6. The apparatus as recited in claim 1, wherein said AFD element further comprises:
a data normalizing element, configured to generate and store for use by said run time modeling element, equations used to normalize said data samples and said synthesized datapoints, along with corresponding properties of said data samples and said synthesized datapoints.

7. The apparatus as recited in claim 1, wherein said AFD element further comprises:
a virtual datapoint creating element, configured to estimate said synthesized datapoints are required by said one or more fault algorithms during execution by said run time modeling element.

8. An apparatus for detecting faults of components, the apparatus comprising:
a building management system (BMS), configured to control and monitor operative states of the components, and configured to generate data samples of said operative states;
an automatic fault detection (AFD) element, coupled to said BMS, configured to monitor, in real time, said data samples, and configured to employ said data samples and synthesized datapoints to determine if one or more of the components are faulty, said AFD element comprising:
a run time modeling element, configured to employ said data samples and said synthesized datapoints as inputs to execute one or more fault algorithms retrieved from a system configuration model, and configured to generate outputs to said one or more fault algorithms that indicate if said one or more of the components are faulty, wherein employment of said synthesized datapoints increases fault coverage, resulting in a reduction of false alarms; and
a fault detection algorithm element, coupled to said system configuration model, configured to employ normalized and standardized datapoints representing said data samples and said synthesized datapoints to automatically select said one or more fault algorithms for storage in said system configuration model, wherein said one or more fault algorithms are selected from a standard fault algorithm data base.

9. The apparatus as recited in claim 8, wherein said AFD element is also coupled to one or more energy consumption meters, and wherein said run time modeling element additionally employs energy consumption data generated by said one or more energy consumption meters as inputs to said one or more fault algorithms.

10. The apparatus as recited in claim 9, wherein said AFD element is coupled to an analytics server, and wherein said analytics server is configured to provide additional data for use by said fault detection algorithm element in selection of said one or more fault algorithms.

11. The apparatus as recited in claim 10, wherein said additional data comprises meteorological data, a building plan, a site survey, or installer notes.

12. The apparatus as recited in claim 8, wherein said system configuration model comprises one or more subsystems of related ones of the components, and wherein said related ones of the components are tagged according to type, size, and relative location.

13. The apparatus as recited in claim 8, wherein said AFD element further comprises:
a data normalizing element, configured to generate and store for use by said run time modeling element, equations used to normalize said data samples and said synthesized datapoints, along with corresponding properties of said data samples and said synthesized datapoints.

14. The apparatus as recited in claim 8, wherein said AFD element further comprises:
a virtual datapoint creating element, configured to estimate said synthesized datapoints that are be required by said one or more fault algorithms during execution by said run time modeling element.

15. A method for detecting faults of components monitored by a building management system (BMS), the method comprising:
monitoring, in real time, data samples generated by the BMS indicating operative states of the components, and employing the data samples and synthesized datapoints to determine if one or more of the components are faulty, said monitoring comprising:
first using the data samples and the synthesized datapoints as inputs to execute one or more fault algorithms retrieved from a system configuration model, and generating outputs to the one or more fault algorithms that indicate if the one or more of the components are faulty, wherein employing the synthesized datapoints increases fault coverage, resulting in a reduction of false alarms; and
second using normalized and standardized datapoints representing the data samples and the synthesized datapoints to automatically select the one or more fault algorithms for storage in the system configuration model, wherein the one or more fault algorithms are selected from a standard fault algorithm data base.

16. The method as recited in claim 15, wherein said first using comprises:
third using energy consumption data generated by the one or more energy consumption meters as inputs to the one or more fault algorithms.

17. The method as recited in claim 16, further comprising:
providing additional data for said second using in selection of the one or more fault algorithms.

18. The method as recited in claim 17, wherein the additional data comprises meteorological data, a building plan, a site survey, or installer notes.

19. The method as recited in claim 15, wherein the system configuration model comprises one or more subsystems of related ones of the components, and wherein the related ones of the components are tagged according to type, size, and relative location.

20. The method as recited in claim 15, further comprising:
generating and storing for use by said first using, equations used to normalize the data samples and the synthesized datapoints, along with corresponding properties of the data samples and the synthesized datapoints.

21. The method as recited in claim 15, further comprising:
estimating the synthesized datapoints that are be required by the one or more fault algorithms during execution by said first using.
